(19) United States
(12) Patent Application Publication
(10) Pub. No.: US 2006/0286216 A1
(43) Pub. Date: Dec. 21, 2006

(54) System for packaging a food portion

(75) Inventor: Hassane Outzinout, Chauve (FR)

Correspondence Address: BAKER & DANIELS LLP;111 E. WAYNE STREET, SUITE 800, FORT WAYNE, IN, 46802, US

(73) Assignee: KNAUF SNC, Wolfgantzen (FR)

(21) Appl. No.: 11/345,507

(22) Filed: Feb. 1, 2006

(30) Foreign Application Priority Data
May 13, 2005 (FR) 05 51 252

(51) Int. Cl. A23B 7/148; B65D 1/00; B65D 90/02

(52) U.S. Cl. 426/106; 229/406; 220/675

(57) ABSTRACT

The packaging system comprises a reusable plate (1) with a base (10) and an edge (11), designed to receive a food portion, a disposable, heat-formed tray (2) receiving the plate (1) and a sealing film.

The tray (2) conforms to the contour of the plate (1), with a flat base (20), a peripheral side (21) terminating at the top part with a flat edge (22) provided with a lug (23) for receiving the film (3).

The point where the peripheral side (21) and the base (20) meet has two parallel indentations (26) for overlapping with two parallel guides (30), the base (20) being supported on a conveyor (31) in order to be conveyed between the different dispensing and sealing stations in a precise orientation.

### FIELD OF THE INVENTION

The present invention relates to a system of packaging a portion of food intended to be reheated/heated for a catering service, in particular in hospitals, retirement homes and collective catering services, which food portions are prepared and presented on the plate in advance, in readiness for heating at the time of the meal.

### BACKGROUND ART

Heat-formed trays are used in various applications and in particular for packaging food products, especially, but not exclusively, products which can be heated or reheated in a microwave oven.

### OBJECTIVE OF THE INVENTION

The objective of the present invention is to develop a packaging system for presenting portions of food, such as meals, under standard conditions, comprising a plate with a food portion prepared in advance and a sealing film applied automatically on a packaging line.

### DESCRIPTION AND ADVANTAGES OF THE INVENTION

To this end, the invention relates to a packaging system of the type defined above, characterised in that it comprises:
a re-usable plate with a base and an edge, designed to receive the food portion,
a disposable thermo-formed tray receiving the plate,
a sealing film covering the tray assembled with the plate to preserve it during transport and reheating,
the film and the tray being removed so that the filled plate can be presented alone with a view to consumption of the food,

which tray conforms to the contour of the plate, having a flat base, a peripheral side terminating at the top part with a flat edge provided with a lug for receiving the film,

the point where the peripheral side and the base meet forming a seating for positioning the base of the plate,

the point where the peripheral side and the base meet having two parallel indentations for overlapping two parallel guides, the base being supported on a conveyor so that it can be conveyed between the different dispensing stations and then into the sealing station in a precise orientation.

The packaging system proposed by the invention offers the advantages of both appearance and the use of a traditional reusable plate, rather than a disposable receptacle, for presenting the food portion or meal, whilst enabling this food portion to be prepared and packaged automatically in a preparation and packaging line, including sealing of the food portion in order to protect it. The packaging tray is made from a thermoplastic material and is designed to hold, surround and protect the plate garnished with the food portion and receive the film.

This shape of tray lends itself to use in an automatic packaging line due to the precise positioning of this tray. It is therefore possible to dispense the different constituents of a meal in this tray automatically and then deposit the sealing film with its tear-off tab for opening the sealing film on the top of the tray. This film is positioned automatically, due to the precise orientation of the tray.

The plate is recovered, which enables selective sorting of the heat-formed trays with a view to possible recycling.

The indentation advantageously has a straight cross-section and is an extension of an inner shoulder of the peripheral side.

This specific shape of the indentation renders deformation in the contour of the plate practically imperceptible, both from the outside and from the inside.

In one variant, the indentations are discontinuous and globally define support surfaces for the parallel guides.

This shape of indentation, for example with bosses defining support surfaces against the guides, reduces the contact zones with the guides or bars.

In one particular embodiment, the indentations extend in the direction parallel with the median plane intersecting the lug of the edge. This common orientation facilitates production of the mould and orientation at the different stations of the packaging line along the median plane of the line of trays or plates.

By virtue of another advantageous feature, the direction of the indentations and that of the median plane intersecting the lug of the edge subtend an angle that is not 0 and is between 30 and 60°.

This inclination of the position of the lug relative to the direction of the guides of the tray and hence the direction of the conveyor enables the lug to be placed in the free space between the contour of two successive trays on the conveyor, which saves space because the trays can then be in contact with each other at their rounded edge and not at the lug and the rounded edge.

### DRAWINGS

The present invention will be described in more detail below with reference to an embodiment of how a heat-formed tray proposed by the invention is made, illustrated in the appended drawings, of which:

FIG. 1 is a perspective view of a packaging system comprising a plate and a heat-formed tray, this system being shown in section through the median plane or plane of symmetry,

FIG. 2 is a view in section through a median plane perpendicular to the plane of symmetry of the packaging system illustrated in FIG. 1,

FIG. 3 is a perspective view of the tray without the plate,

FIG. 4 is a plan view of the tray disposed in a packaging line,

FIG. 5 is a partial section of the tray through a plane which does not intersect the indentations.

### DESCRIPTION OF AN EMBODIMENT OF THE INVENTION

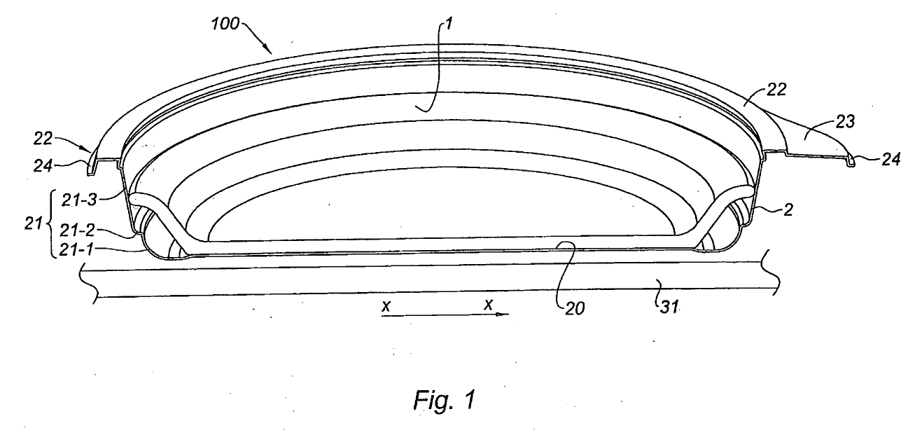

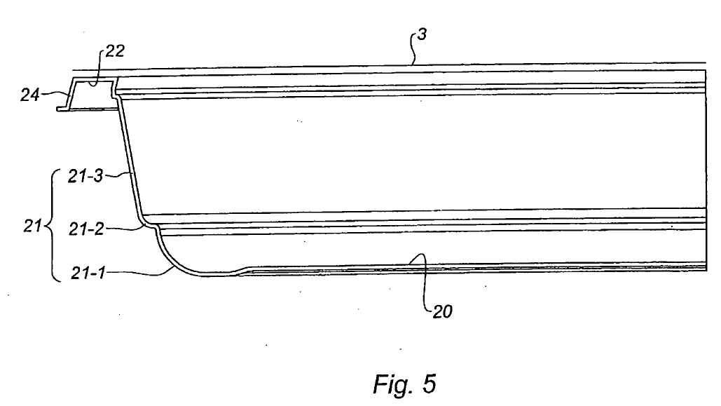

As illustrated in FIGS. 1 to 3, the invention relates to a system for packaging a portion of food. This system 100 comprises a plate 1, designed to receive the food portion, and a heat-formed tray 2 receiving the plate, the system being closed by means of a sealed film 3 (FIG. 5) in order to preserve the food portion once it has been prepared and before it is consumed, with a view to transportation, storage and handling.

The plate 1 and the tray 2 are illustrated in two perpendicular sections, indicating the shape of the each of the two parts of this system 100 prior to applying the film.

This plate 1 is conventionally in the shape of a revolution, i.e. has a circular or possibly oval shape, with a base 10 and a raised edge 11.

It is preferably made from ceramic. It is re-usable and holds the food portion. The expression “food portion”, is meant in the general sense. It may be a variety of different foods placed on the plate either before the plate has been placed in the tray or after the empty plate has been placed in it.

The heat-formed tray 2 receiving the plate 1 is of a shape complementing that of the plate, for example round or oval. It has a base 20 on which the plate 1 sits and a peripheral side adapted to the shape of the plate in order to seat it and reduce contact between the plate and the tray to a minimum; the plate is therefore placed on the base of the tray and is supported by the tip of its edge against the peripheral side of the tray.

More specifically, the shape of the tray 2 itself is that of a round, possibly oval, plate with a flat base 20. It has a peripheral side 21 terminating at the top part in a flat edge 20, extended by a lug 22. The peripheral edge 22 comprises a rounded part 21-1 extending down underneath the flat base 20 and rising towards a shoulder 21-2 and then continuing into a truncated conical part 21-3. The edge 22 has a trapezoidal shape extending back down towards the exterior by means of a ledge 24; overall, its shape is that of an upturned U, in order to make the system more rigid. This downwardly extending ledge 24 runs around the entire contour of the tray, including the contour of the lug 23. The top of the edge 22 is flat and is higher than the top of the lug 23.

At the joint between the peripheral edge 21 and the base 20, the rounded part 21-1 is interrupted by two parallel rectilinear indentations 26, having the shape of a circle segment. These indentations are disposed underneath the shoulder 21-2 of the peripheral side and are parallel with a direction XX, for example that of the median plane of symmetry. These indentations 26 are designed to overlap with guide bars 30 of a conveyor 31 on which the base 20 of the tray 2 is supported as it passes through the different stations at which products are dispensed and the film is applied. These stations are not illustrated.

In one variant, the surface of the indentations guided by the guides or bars may be of a discontinuous shape which is rectilinear overall, for example due to a series of bosses defining the surface supported on the rails.

The tray 2 provided with the film can be reheated in a microwave oven.

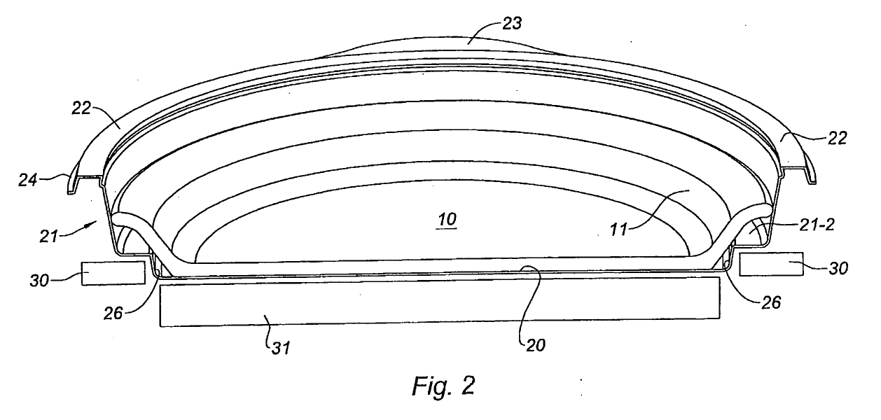

The film 3 has a rounded shape conforming to the contour of the edge 22, to which it is adhered or heat-welded; it also terminates in an extension with the same shape as the lug. To avoid complicating the drawings of FIGS. 1 and 2 showing the plate without any contents, the film 3 is illustrated in FIG. 5 only. The film 3 is sealed on the peripheral edge but not on the lug, so that it forms a tear-off tab with a large surface area so that the film can be easily gripped and removed whilst holding the tray by its lug 23 without any risk of spilling the contents of the plate 1.

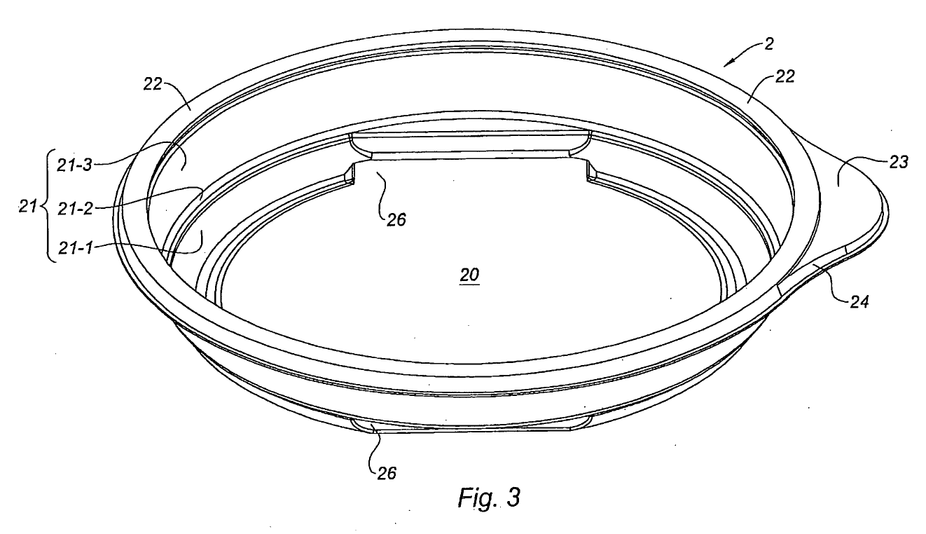

The perspective view illustrated in FIG. 3 shows the different elements of the tray 2, its gripping lug 23, its indentations 26 on the peripheral side 21 as well as the different elements making up the peripheral side 21 and the edge 22.

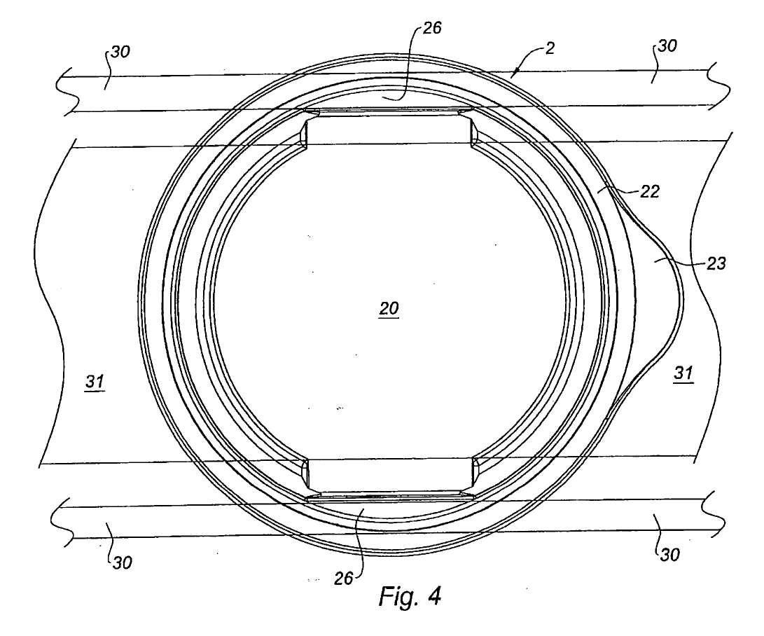

FIG. 4 is a plan view showing the heat-formed tray illustrated in FIGS. 1 and 2, placed on a conveyor 31 and guided between the parallel guides 30 or bars of the conveyor for passing through the different stations at which the products are dispensed and then the film is applied, so that they stay in a precise orientation throughout the transfer.

FIG. 5 is an axial section showing the shape of the tray, highlighting the shape of its linear section.

This view also highlights the downwardly extending shape of its peripheral side down to below the plane of the base 20.

In one variant, not illustrated, the lug 23 is not disposed in the median plane relative to the indentations 26 but is offset from this direction at an angle of between 30 and 60°. This different orientation between the axis of the tray intersecting the lug and the axis XX of the indentations 26 enables the tray/plate systems to be placed edge to edge on the conveyor, the lug 23 always being offset and fitting in the free space between the two contours of successive trays. This enables a higher density occupation of the conveyor or packaging line.

1) System for packaging a food portion intended to be reheated/heated for a catering service, in particular hospitals, retirement homes and collective catering services, which food portions are prepared and presented in the plate in advance for reheating at the time of the meal, characterised in that
it comprises
a reusable plate (1) with a base (10) and an edge (11), designed to receive the food portion,
a disposable, heat-formed tray (2) receiving the plate (1),
a sealing film (3) covering the tray (2) incorporating the filled plate (1) in order to preserve it during transportation and reheating,
the film (3) and the tray (2) being removed in order to present the filled plate (1) on its own with a view to consumption of the food,
the tray (2) conforming to the contour of the plate (1) with a flat base (20), a peripheral side (21) terminating at the top part in a flat edge (22) provided with a lug (23) for receiving the film (3),
the point (21-1) where the peripheral side (21) and the base (20) meet forming a seating for positioning the base (10) of the plate (1),
the point where the peripheral side and the base meet having two parallel indentations (26) designed to overlap with two parallel guides (30), the base (20) being supported on a conveyor (31) in order to be conveyed between the different dispensing stations and then to the sealing station in a precise orientation.

2) Packaging system as claimed in claim 1,
characterised in that
the indentation (26) has a straight section and is an extension of an inner shoulder (21-2) of the peripheral side (21).

3) Packaging system as claimed in claim 1,
characterised in that
the indentations (26) are discontinuous and overall define the surfaces supported by the parallel guides (30).

4) Packaging system as claimed in claim 1,
characterised in that
the direction (XX) of the indentations (26) is parallel with the median plane intersecting the lug (23).

5) Packaging system as claimed in claim 1,
characterised in that
the direction of the lug (23) of the tray (2) subtends and angle of between 30 and 60° with the direction XX of the indentations (26).

6) Packaging system as claimed in claim 1,
characterised in that
the plate (1) is made from ceramic, porcelain or a vitreous material.
